(19) United States
(12) Patent Application Publication
(10) Pub. No.: US 2024/0270103 A1
(43) Pub. Date: Aug. 15, 2024

(54) FLOOR ASSEMBLY FOR INDUCTIVE CHARGING DEVICE

(71) Applicant: MAHLE International GmbH, Stuttgart (DE)

(72) Inventors: Mike Boettigheimer, Kornwestheim (DE); Thomas Himmer, Reichenbach (DE); Christopher Laemmle, Stuttgart (DE); Holger Schroth, Maulbronn (DE); Martin Steinbach, Waiblingen (DE)

(21) Appl. No.: 18/568,835

(22) PCT Filed: May 24, 2022
(86) PCT No.: PCT/EP2022/064084

§ 371 Date: Dec. 10, 2023

(30) Foreign Application Priority Data
Jun. 11, 2021 (DE) 10 2021 205 979.1

(51) Int. Cl. B60L 53/302; B60L 53/12

(52) U.S. Cl. CPC B60L 53/302; B60L 53/12

(57) ABSTRACT

A floor assembly for an inductive charging device for inductive charging of a motor vehicle parked on an underground may include a base plate extending transversely to a spacing direction, at least one flat coil disposed spaced apart from the base plate in the spacing direction, a core arrangement for guiding a magnetic flux, and at least one elastic heat-conducting element. The flat coil may include a conductor. The core arrangement may be disposed spaced apart from the base plate and the flat coil in the spacing direction. The core arrangement may include at least one core body extending transversely to the spacing direction in the form of a plate. A lower cavity may be formed between the core body and the base plate. The core body may be connected to the base plate in a heat-transferring manner via the heat-conducting element, which may extend through the lower cavity.

### CROSS-REFERENCE TO RELATED APPLICATIONS

This application claims priority to International Patent Application No. PCT/EP2022/064084, filed on May 24, 2022, and German Patent Application No. DE 102021205979.1, filed Jun. 11, 2021, the contents of both of which are hereby incorporated by reference in their entirety.

### TECHNICAL FIELD

The present invention relates to a floor assembly for an inductive charging device for inductive charging of a motor vehicle.

### BACKGROUND

In the case of at least partially electrically powered vehicles, regular charging of the vehicle's electrical energy storage system is necessary. In principle, a cable connection can be established between the vehicle and an external electrical energy source for this purpose. However, this requires manual action by a user.

It is also known to inductively charge the motor vehicle, i.e., in particular the electrical energy storage device, which can be an accumulator, for example. Corresponding charging devices for this purpose each have an assembly in the vehicle and outside it. The assembly outside the vehicle contains a primary coil which interacts inductively with a secondary coil of the assembly in the vehicle in order to charge the energy storage unit. The assembly in the vehicle is also referred to as a vehicle assembly. The assembly outside the vehicle is usually located underneath the vehicle during operation and is referred to as the floor assembly.

During operation of the charging device, heat can be generated in the respective assembly, in particular in the floor assembly, especially due to the charging power to be provided. In the case of the floor assembly, this heat can lead to an undesirable rise in temperature of the floor assembly and/or neighboring objects and thus also to derating (reduction in charging power due to excessive heat in the system) or failure of the system during charging.

### SUMMARY

The present invention therefore deals with the problem of providing an improved or at least different embodiment for a base assembly for an inductive charging device of the type mentioned at the beginning, which in particular overcomes the disadvantages known from the prior art.

According to the invention, this problem is solved by the subject matter of independent claim(s). Advantageous embodiments are the subject matter of the dependent claim(s).

The present invention is based on the general idea of improving power transmission when charging an electric vehicle by means of a floor assembly according to the invention with a base plate and a core arrangement with core bodies and a flat coil supported above it via at least one support, in that the base plate is designed as a cooling plate and at least one core body is connected to the base plate in a heat-transferring manner via at least one elastic heat-conducting element and can thus be actively and effectively cooled. The base plate, which is designed as a cooling plate, extends transversely to a spacing direction in the form of a plate. The spacing direction is the surface normal of the base plate and is usually vertical when installed. A magnetic field for inductive charging can be generated via the flat coil, which serves as the primary coil and has at least one spirally wound conductor, for example. The flat coil is spaced apart from the base plate and the core bodies. Also provided is a core arrangement for magnetic flux guidance, which is spaced apart from the base plate and the flat coil and arranged between the base plate and the conductor. Part of this core arrangement is at least one core body, which extends transversely to the spacing direction in the form of a plate and has a central region and at least one edge region and is held via its edge region. A lower cavity is formed between the at least one core body and the base plate, through which the elastic heat-conducting element extends from the central area of the associated core body to the base plate and connects the latter to the base plate in a heat-transferring manner. The elastic heat-conducting element, which is arranged in the central area of the associated core body, can be used to effectively dissipate heat from, for example, the flat coil or the core arrangement into the cooling plate and thus cool or cool the flat coil, the core arrangement with the ferrite plates, which can enable a higher current or a higher charging power with the same conductor cross-section or the same current or the same charging power with a smaller conductor cross-section. Another major advantage is that in the central area of the respective core body, the magnetic flux density generated there by the current flowing in the conductor of the flat coil is sufficiently low, so that an arrangement of the heat conducting element in this area, even if it is made of metal, is not critical with regard to the impairment of the magnetic flux density. With the floor assembly according to the invention, it is thus possible to operate it with a comparatively high charging power due to the heat-conducting elements, whereby undesirable heating, in particular overheating, which would have to reduce the charging power, can be avoided.

The floor assembly according to the invention can be arranged recessed in a substrate, in particular flush with the surface thereof, although alternatively it is of course also conceivable to arrange it on the substrate.

The central area is thereby limited by, for example, 80% of a diameter of the individual core bodies in the longitudinal direction and width direction, preferably 70% of the diameter of the individual core bodies in the longitudinal direction and width direction, particularly preferably 50% of the diameter of the individual core bodies in the longitudinal direction and width direction and very particularly preferably 30% of the diameter of the individual core bodies in the longitudinal direction and width direction.

In particular, advantages can also be achieved with regard to large-scale production, as the elastic heat conducting elements can compensate for production-related manufacturing tolerances that occur during the manufacture of the individual components for the floor assembly, which can even add up in so-called tolerance chains. Previously known base assemblies with usually mechanically rigid superstructures do not contain any features for a special compensation of z-tolerances (distance direction) within a thermal heat conduction path between the core bodies and the base plate designed as a cooling plate. Therefore, either the tolerance chain in the z-direction would have to be limited to a few 1/100 mm in order to ensure sufficiently good thermal contacts, or a 0.5-3 mm thick, subsequently curing layer would have to be installed in the thermal heat conduction path, which has both good thermal conductivity and is also solid enough to be able to transfer the mechanical loads from a vehicle crossing if necessary. Both variants are not suitable for mass production due to high development and production costs and can be avoided by the floor assembly according to the invention.

In an advantageous further development of the solution according to the invention, the at least one heat conducting element has a thermal resistance Rₜₕ between a connection surface to the core body and a connection surface to the base plate of Rₜₕ<0.5 K/W, preferably Rₜₕ<0.3 K/W, particularly preferably Rₜₕ<0.1 K/W. The use of materials with a thermal conductivity of λ>10 W/(m-K), in particular a thermal conductivity of λ>50 W/(m-K) or λ>100 W/(m-K), is particularly suitable for this purpose. The material for the respective heat conducting elements can therefore be, for example, iron with a thermal conductivity λ of approx. 80 W/(m-K), but also aluminum with a thermal conductivity λ of 235 W/(m-K) or copper with a thermal conductivity λ of 401 W/(m-K). The use of aluminum also has further advantageous properties (light, easy to solder with aluminum cooling plate, no corrosion, very good electrical conductivity, thus fewer losses due to lower eddy currents). As an alternative to metallic materials, non-metallic materials such as graphite or graphite foils are also conceivable for the heat conducting elements. Combinations of the above or other suitable materials (e.g. ceramic) are also possible.

In an advantageous further development of the solution according to the invention, the at least one heat conducting element is at least partially made of metal, in particular aluminum. Due to the connection in the central area of the core body, in which a magnetic field and thus a magnetic flux density is not or only marginally influenced, even a metallic heat conducting element can be used.

In an advantageous further development, the base plate has at least one cooling channel for a coolant. This enables active cooling of the base plate during operation and the core assembly above it. In addition, the actively cooled base plate in turn cools the air inside the lower cavity, making it possible to cool the electronics located there as well as the core arrangement or core body located above the lower cavity. Areas on which the respective supports rest on the base plate preferably have no cooling channels in order to ensure sufficient pressure stability.

The base plate itself is advantageously made of a metal or a metal alloy, for example aluminum, in order to improve heat transfer between the coolant, base plate, heat conducting elements and core bodies. The spaced arrangement of the base plate relative to the flat coil and the core arrangement also minimizes or at least reduces magnetic or electromagnetic interaction between the base plate and the flat coil and the core arrangement. The distance between the base plate and the core arrangement in the spacing direction can be between several millimeters and several centimeters. By manufacturing the base plate from metal or a metal alloy, the floor assembly is also electromagnetically shielded from the ground below.

In a further advantageous embodiment of the floor assembly according to the invention, the at least one heat conducting element is designed as a sheet metal strip or as a sleeve with a thickness d of 0.5 mm<d<2.0 mm. Elastic heat conducting elements between core bodies and base plates (heat sinks) essentially have three functional areas, namely the contact surface to the core body, the elastically deformable area between the core body and base plate and the contact area on the base plate.

For example, a z-shaped metal strip can be used to create a large-area contact on the core body and the base plate as well as an elastic intermediate area, which makes it possible to compensate for production-related manufacturing tolerances. A heat conducting element designed as a sleeve can, for example, be rolled or embossed and/or have an axially planar end area for contact with the core body or the base plate. Sheet metal sleeves are also conceivable, especially in a cup shape. Such sheet metal sleeves can be deep-drawn, rolled, hydroformed or embossed. The area of the heat conducting element located between the base plate and the core body can also have a special heat dissipating shape, for example with wings, especially if, for example, air flows through the lower cavity between the core body and the base plate and this additionally supports cooling.

At least one support is conveniently provided between the core body and the base plate, which extends through the lower cavity in the spacing direction and supports at least one core body at its edge area. The at least one support can The at least one support can be made of plastic. made of plastic. Due to the support of the core bodies at their respective edge areas, where a strong magnetic field prevails, it is advantageous to use plastic supports that do not influence the magnetic field.

In an advantageous further development of the invention, it is provided that a buffer element is arranged between the base plate and at least one support. A buffer element of this type can be used to further reduce the load on the core body. This ensures that the core bodies can follow an uneven settlement during a crossing without building up excessive bending stresses in the ferrite material and thereby increasing the risk of breakage. Such a buffer element can be made of an elastomer (hardness e.g. like car tires, Shore A 50 . . . 70).

The at least one heat-conducting element is conveniently connected to the associated core body and the base plate via a heat-conducting layer, for example a thermal oil, an adhesive, a thermal grease, a heat-conducting paste or solder. All contact surfaces of the heat conducting element with the core body and/or the base plate can be contacted by a roughness-compensating thermal interface material (heat-conducting paste, thermal grease, thermal oil with high viscosity) or an adhesive film, if required, which can improve the heat transfer. Furthermore, clip structures or even screws can be used to support or ensure the correct fit of the heat conducting element.

A spring stiffness D of the at least one heat conducting element in the spacing direction is 13 N/mm<D<130 N/mm in order to avoid plastic deformation in the normal operating state. If the elastic heat conducting element has a spring stiffness below the required stiffness or can deform plastically with the expected deformations and thus limit the resilience, the heat conducting element can be surrounded by an additional support structure made of a different material (plastic, elastomer, possibly metal). This support structure can be connected to the heat conducting element in a form-fit, force-fit or material-fit manner. Furthermore, the area of the heat conducting element located between the core body and the base plate can be slotted if necessary to adjust the spring stiffness.

It is also conceivable that the at least one heat-conducting element is mechanically attached to both the base plate and the core body in such a way that after an elastic, i.e. resettable, change in the lower intermediate space between the base plate and the core body, for example due to a vehicle crossing, the one heat-conducting element is also returned to its original position by the deformation of the base plate or core body itself, which is mechanically attached to the heat-conducting element. In this case, the heat conducting element requires little or no resilience of its own. Such a design is conceivable, for example, by using a short copper strand whose length is between 20 mm and 100 mm longer than the distance in the spacing direction between the base plate and the core body. The twists of the individual strands are resolved at both ends of the strand in such a way that there is a piece of strand with intact twist in the middle, the length of which is at most 20 mm shorter or at most 20 mm longer than the distance between the base plate and the core body. The disintegrated individual strands at the ends are each arranged to form a plate-shaped object so that the intact middle section of the strand represents a surface normal to the alignment plane of the plate-shaped object. Subsequently, the plate-shaped objects arranged from the dissolved individual wires are fixed, e.g. by penetrating them with solder material. Such an object, which is soft in the axial direction of the center part, is compact in itself, has a high thermal conductivity in this axial direction but almost no mechanical rigidity, and can be mechanically and thermally connected to the plate-shaped objects arranged at the ends over a large area by soldering both to the base plate and to a distributor plate attached to the core body.

A distributor plate or a distributor layer can be conveniently arranged between at least one heat conducting element and the associated core body. The manifold plate can be connected to the core body via an adhesive layer with a thermal conductivity of λ>0.8 W/(m-K) and/or a shear modulus of G<10 MPa. As the adhesive layer, for example a layer of adhesive, is extremely thin, a low thermal conductivity λ of λ>0.8 W/(m-K) is also sufficient here. In order to also be able to compensate for different thermal expansion coefficients between the core bodies, for example a ferrite plate, and the distributor plate, it is advantageous to provide the adhesive layer or the adhesive layer in general with a shear modulus G>10 MPa.

Other important features and advantages of the invention can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

They show, schematically in each case,

FIG. 1 is a highly simplified sectional view of an inductive charging device with a floor assembly according to the invention and a motor vehicle,

FIG. 2 shows an illustration as in FIG. 1, but without a motor vehicle and with other heat-guiding elements,

FIG. 3 shows a detailed illustration of a bottom assembly according to the invention with a stepped heat-conducting element,

FIG. 4 shows a detailed illustration of a bottom assembly according to the invention with a z-shaped heat-conducting element,

FIG. 5 shows a detailed illustration of a bottom assembly according to the invention with a concave sleeve-shaped heat-conducting element,

FIG. 6 shows a detailed illustration of a bottom assembly according to the invention with two C-shaped heat-conducting elements,

FIG. 7 shows a detailed illustration of a bottom assembly according to the invention with a trough-shaped heat-conducting element,

FIG. 8 shows an illustration as in FIG. 7, but with additionally elastically supported supports,

FIG. 9 shows a detailed illustration of a bottom assembly according to the invention with a heat-guiding element with strands.

### DETAILED DESCRIPTION

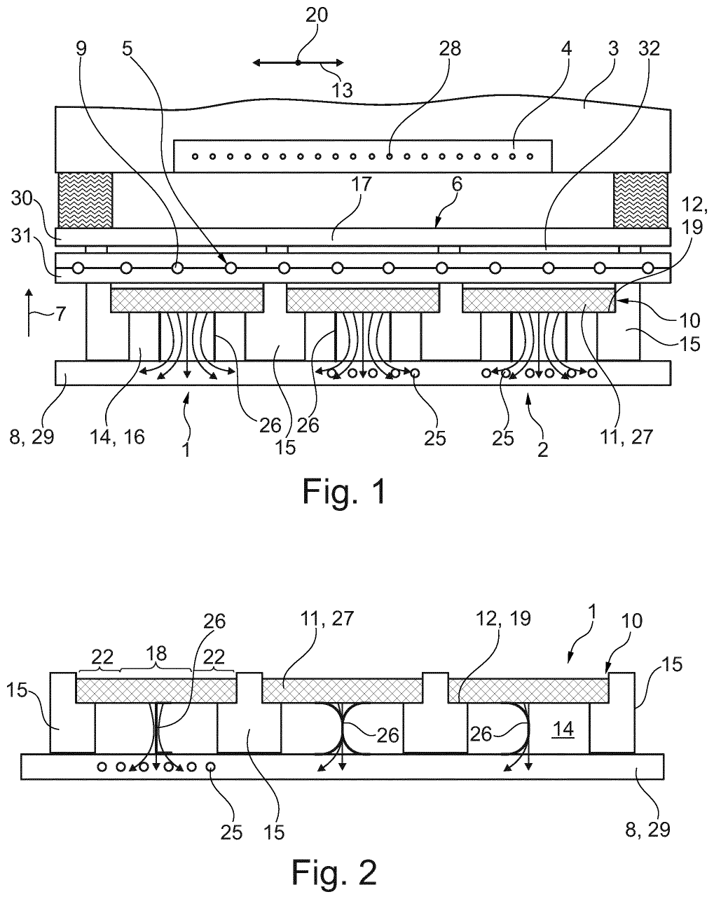

A floor assembly 1 according to the invention, as shown for example in FIGS. 1 through 9, is used in a charging device 2 shown in FIG. 2 for inductive charging of a motor vehicle 3. For this purpose, the floor assembly 1 interacts with an associated assembly 4 of the motor vehicle 3, for example a secondary coil 28. The interaction takes place in particular between a flat coil 5 of the floor assembly 1, which serves as the primary coil of the charging device 2, and the secondary coil 28 of the assembly 4 of the motor vehicle 3. The motor vehicle 3 is parked on an underground 6 for inductive charging using the charging device 2. In the exemplary embodiment shown, the floor assembly 1 is recessed into the underground 6, but can also be arranged on top of it.

The base assembly 1 has a base plate 8, in particular in the form of a cooling plate 29, which extends transversely to a spacing direction 7. The spacing direction 7 runs parallel to a normal of the underground 6 and in particular along the perpendicular direction. As shown in FIG. 1, the flat coil 5 is spaced apart from the base plate 8 in the spacing direction 7 and comprises a spirally wound conductor 9, which can be made of copper, for example. The floor assembly 1 further comprises a core arrangement 10 with at least one core body 11, which can be designed as a ferrite plate 27. The core body 11 can be made of a soft magnetic material, in particular a soft magnetic ferrite.

The core arrangement 10 is spaced from the flat coil 5 in the spacing direction 7. Here, the core arrangement 10 with the at least one core body 11 is arranged between the base plate 8 and the flat coil 5.

As can be seen from FIGS. 1 through 8, the floor assembly 1 of the embodiments shown has several core bodies 11, which are rectangular and of identical design, for example. The respective core body 11 extends plate-like in the width direction 13 and in a longitudinal direction 20 running transversely to the width direction 13 and transversely to the spacing direction 7, the longitudinal direction 20 running perpendicular to the image plane.

The core arrangement 10, in particular its at least one core body 11, is supported on supports 15 (see FIGS. 1-8). The supports 15 can be connected to the core bodies 11 via a respective form-fit connection 19, for example a step 12, and fix them in the spacing direction 7 and transversely thereto. The supports 15 can be columnar or wall-like and/or made of plastic. Due to the support of the core bodies 11 at their respective edge areas 22, in which a high magnetic flux density prevails, it is advantageous to use plastic supports 15 here, which do not influence the magnetic field. In the embodiment examples shown, the supports 15 are arranged with respect to an associated core body 11 at the edge of the associated core body 11, i.e. at the edge in the width direction 13 and in the longitudinal direction 20. The core bodies 11 each have a central region 18 and at least one edge region 22, the core bodies 11 being supported on the steps 12 of the supports 15 via their respective edge region 22. A lower cavity 14 is formed between the core bodies 11 and the base plate 8, wherein at least one core body 11 is connected to the base plate 8 in a heat-transferring manner via at least one elastic heat-conducting element 26 and wherein the heat-conducting element 26 extends from the central region 18 of the associated core body 11 through the lower cavity 14 to the base plate 8 and connects the latter to the base plate 8 in a heat-transferring manner. The elastic heat-conducting element 26, which is in contact with the associated core body 11 in the central area 18 of the latter, can be used to effectively dissipate heat from, for example, the flat coil 5 or the core arrangement 10 into the cooling plate 29 and thus to cool the flat coil 5, the core arrangement 10 with the ferrite plates 27, which can enable a higher charging power with the same conductor cross-section or the same charging power with a smaller conductor cross-section. A further great advantage results from the fact that in the central area 18 of the respective core body 11, a magnetic flux density generated there by the current flowing in the conductor 9 of the flat coil 5 is sufficiently low, so that an arrangement of the heat conducting element 26 in this area, even if it is made of metal, is uncritical with regard to the impairment of the magnetic flux density.

With the floor assembly 1 according to the invention, it is thus possible to operate it with a comparatively high charging power due to the heat-conducting elements 26, so that undesirable heating, in particular overheating, which would have to reduce the charging power, can be avoided.

According to FIG. 1, the flat coil 5 or its conductor 9 is arranged between an upper and a lower wire support 30, 31, with the lower wire support 31 resting on the supports 15. This means that the core bodies 11 are unloaded, making it possible to transfer loads, for example from motor vehicles 3 traveling on the floor assembly 1, exclusively via the supports 15 into the base plate 8. The supports 15 only partially fill the lower cavity 14 so that a flow space 16 remains for a fluid, for example air, whereby the core arrangement 10, in addition to the heat conducting elements 26, can transfer heat to the base plate 8 via the air and improve cooling of the core arrangement 10, the core body 11 and the flat coil 5 and consequently increase the efficiency of the base assembly 1.

In FIG. 1, the bottom assembly 1 comprises a cover plate 17. Cavities 32 are provided between the cover plate 17 and the upper wire support 30, in which, for example, a circuit board can be arranged. In the exemplary embodiments shown, the base plate 8 is designed as a cooling plate 29, through which cooling channels 25 for a coolant run. The coolant actively cools the base plate 8 during operation. In addition, the actively cooled base plate 8 in turn cools the air inside the lower cavity 14, which makes it possible to cool the electronics arranged there and also to cool the air of the core arrangement 10 or core body 11 arranged above the lower cavity 14. Areas on which the respective supports 15 rest on the base plate 8 preferably have no cooling channels 25 in order to ensure sufficient pressure stability. The base plate 8 is advantageously made of a metal or a metal alloy, in particular aluminum, in order to improve the heat transfer between the coolant, base plate 8, heat conducting elements 26 and core bodies 11. The spaced arrangement of the base plate 8 relative to the flat coil 5 and to core arrangement 10 minimizes or at least reduces magnetic or electromagnetic interaction of the base plate 8 with the flat coil 5 and the core arrangement 10. By manufacturing the base plate 8 from a metal or a metal alloy, electromagnetic shielding of the floor assembly 1 in the direction of the substrate 6 is achieved at the same time.

The floor assembly 1 according to the invention also offers advantages with regard to large-scale production, since the elastic heat-conducting elements 26 can compensate for production tolerances that occur during the manufacture of the individual components for the floor assembly 1, which can even add up in so-called tolerance chains.

In order to enable the highest possible heat dissipation of the core body 11, the at least one heat conducting element 26 has a thermal resistance Rₜₕ between a connection surface to the core body 11 and a connection surface to the base plate 8 of Rₜₕ<0.5 K/W, preferably Rₜₕ<0.3 K/W, particularly preferably Rₜₕ<0.1 K/W. The use of materials with a thermal conductivity of λ>10 W/(m-K), in particular a thermal conductivity of λ>50 W/(m-K) or λ>100 W/(m-K), is particularly suitable for this purpose. The material for the respective heat conducting elements 26 can therefore be, for example, iron with a thermal conductivity λ of approx. 80 W/(m-K), but also aluminum with a thermal conductivity λ of 235 W/(m-K) or copper with a thermal conductivity λ of 401 W/(m-K). The use of aluminum also has further advantageous properties (light, easy to solder with aluminum cooling plate, very good electrical conductivity, thus fewer losses due to lower eddy currents). As an alternative to metallic materials, non-metallic materials such as graphite or graphite foils are also conceivable for the heat conducting elements. Combinations of the above or other suitable materials (e.g. ceramic) are also possible. A design in which the thermally contacting materials between the core body 11 and the heat conducting element 26 or between the base plate 8 and the heat conducting element 26 are identical is particularly preferable. As the contacting surfaces are made of the same material, there is no risk of contact corrosion.

Due to the connection of the at least one heat conducting element 26 in the central area 18 of the associated core body 11, this can also be at least partially made of metal, in particular aluminum, since an influence on the magnetic field in the central area 18 of the core body 11 does not occur or is only insignificant due to the very low flux density there.

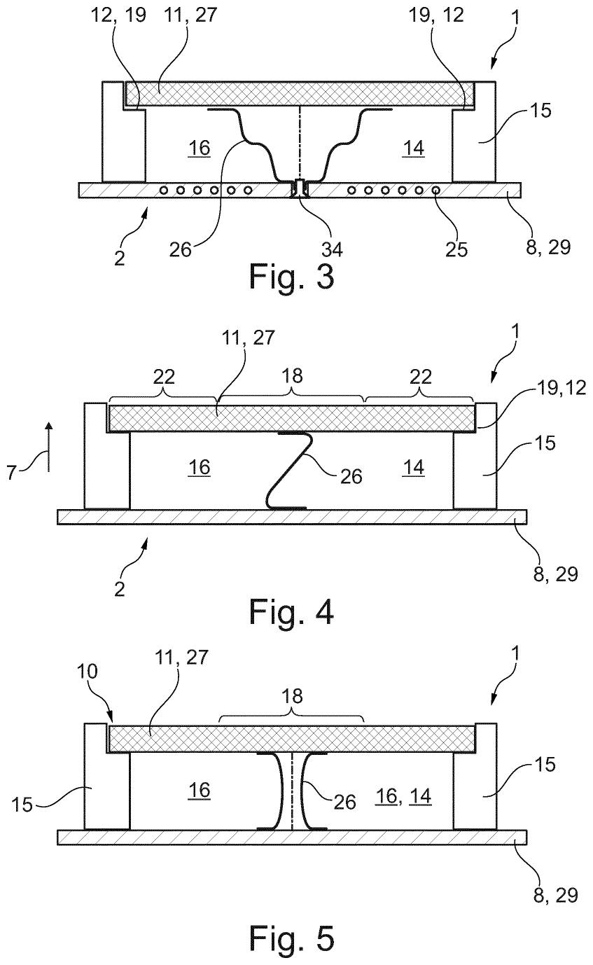

The at least one heat conducting element 26 can be designed as a sheet metal strip (see FIGS. 2-4, 6-8) or as a sleeve (see FIGS. 1 and 5) with a thickness d of 0.5 mm<d<2.0 mm. Furthermore, the at least one heat conducting element 26 can be designed as a rotationally symmetrical element (see FIG. 2 center and right, 3, 5, 7, 8), as a largely rotationally symmetrical element with slots (FIG. 6) or as an element that is prismatically shaped axially in the longitudinal direction 20 (FIGS. 2-8). Elastic heat-conducting elements 26 between core bodies 11 and base plate 8 (heat sink) essentially have three functional areas, namely the contact surface to the core body 11, the elastically deformable area between the core body 11 and the base plate 8 and the contact area on the base plate 8. For example, a z-shaped metal strip (see FIG. 4) can be used to create a large flat contact area on the core body 11 and the base plate 8 as well as an elastic intermediate area, which makes it possible to compensate for production-related manufacturing tolerances. Sheet metal sleeves are also conceivable, particularly in a cup shape (see FIGS. 3, 7 and 8). Such sheet metal sleeves can be deep-drawn, rolled, hydroformed or embossed. By increasing the heat-transferring surface of the heat-conducting element 26 in the lower cavity 14, air cooling can also be used effectively.

The heat-conducting element 26 as shown in FIG. 1 has a rectangular cross-sectional shape with an upper side on the core body 11 and a lower side on the base plate 8. The side walls are elastic and can be extended if necessary. It therefore goes without saying that the heat-conducting element 26 has an extension in the spacing direction 7 that is 0.5 mm to 5.0 mm greater than the largest distance between the core body 11 and the base plate 8 that can be assumed taking into account all tolerance chains, so that the elastic heat-conducting element 26 makes secure contact with both the core body 11 and the base plate 8 in every conceivable installation situation and is slightly preloaded.

According to FIG. 2, a heat conducting element 26 with a U-shaped cross-section is shown on the left, which rests against the core body 11 with an upper U-leg and against the base plate 8 with a lower U-leg.

The heat-conducting element 26 as shown in FIG. 3 has a stepped shape that increases the heat-transferring surface and is also screwed to the base plate 8 with a screw 34. The free legs lie flat against the core body 11. Such a shape can also be suitable for pressing a circuit board arranged in the intermediate space 14 against the base plate 8 and thus against the cooling plate 29, thus also enabling the electrical or electronic components located on the circuit board to be cooled.

In FIG. 4, the heat conducting element 26 has the z-shaped form described above and is therefore also elastic.

The heat conducting element 26 as shown in FIG. 5 has a sleeve-like shape and can, for example, be rolled or embossed and/or have an axially planar end area for contact with the core body 11 or the base plate 8.

The heat-conducting element 26 shown in FIG. 6 has a barrel-like shape or is composed of two c-shaped heat-conducting elements 26. Slots 35 can be made in the area of the heat-conducting element 26, which is located between the core body 11 and the base plate 8, to adjust the spring stiffness.

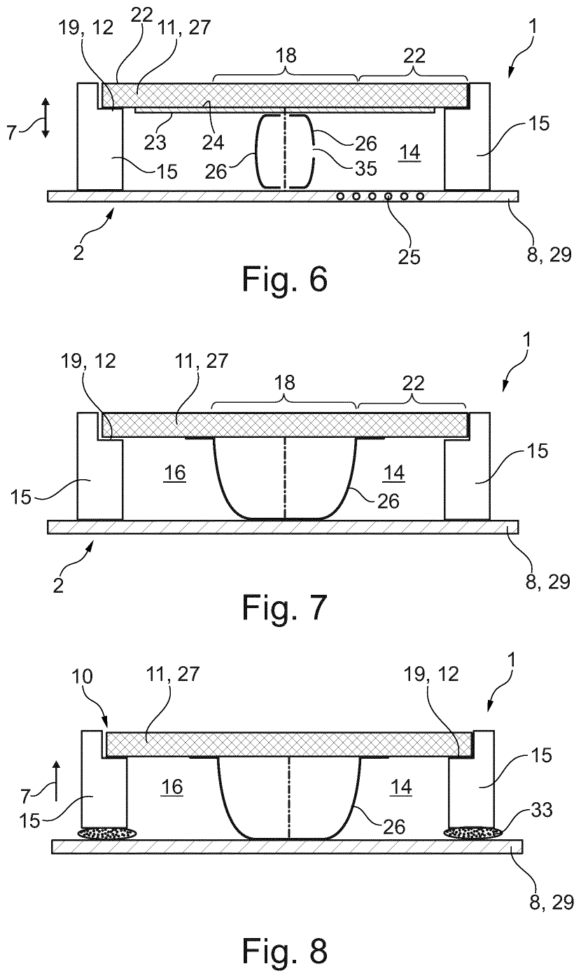

The heat conducting element 26 as shown in FIG. 7 has a trough-like or channel-like shape and is connected to the core body 11 via a trough edge or channel edge and to the base plate 8 via a trough base or channel base. Optimized heat transfer can be achieved through the flat connection to both the core body 11 and the base plate 8.

According to the embodiment shown in FIG. 8, a buffer element 33 is arranged between the base plate 8 and at least one support 15, which can be used to compensate for tolerances of up to 1.0 mm in the spacing direction 7. This ensures that the core bodies 11 can follow uneven settlement without building up excessive bending stresses in the ferrite material and thereby increasing the risk of breakage. Such a buffer element 33 can be made of an elastomer.

All contact surfaces of the heat conducting element 26 with the core body 11, the distributor plate 23, 23a, the distributor layer and/or the base plate 8 can be contacted by a roughness-compensating thermal interface material (heat-conducting paste, thermal grease, thermal oil with high viscosity) or an adhesive film, if required, whereby the heat transfer can be improved. Furthermore, the correct fit of the heat conducting element 26 can also be supported or ensured by clip structures or even screws 34 (see FIG. 3).

A spring stiffness D of the at least one heat conducting element 26 in the spacing direction 7 can be 13 N/mm<D<130 N/mm in order to avoid plastic deformation in the operating state.

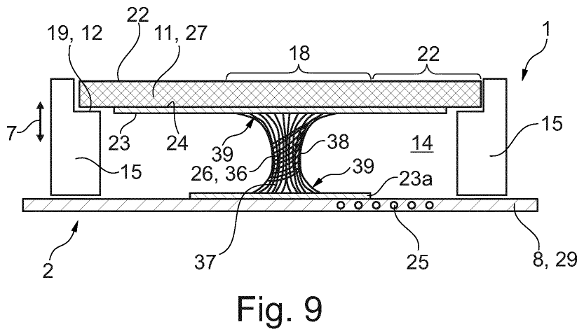

According to FIG. 9, the heat conducting element 26 has a stranded wire 36, in particular a copper strand, the length of which is between 20 mm and 100 mm longer than the distance in the spacing direction 7 between the base plate 8 and the core body 11. The strand 36 is composed of individual wires 37, the twists of which are resolved at both ends of the strand 36 in such a way that in the middle (viewed in the spacing direction 7) there is a piece of strand with intact twist, the length of which falls below the distance between the base plate 8 and the core body 11 by a maximum of 20 mm or exceeds it by a maximum of 20 mm. The disintegrated individual wires 37 at the ends are each arranged to form a plate-shaped object 39 in the mold, so that the intact central portion 38 of the strand 36 represents a surface normal to the alignment plane of the plate-shaped object 39. The plate-shaped objects 39 thus formed from the individual wires 37 are then fixed in place, e.g. by penetrating them with solder material. Such an object, which is soft in the axial direction of the center part, is compact in itself, has a high thermal conductivity in this axial direction but almost no mechanical rigidity, and can be mechanically and thermally connected to the plate-shaped objects 39 arranged at the ends over a large area by soldering both to the base plate 8 and to a distributor plate 23, 23a attached to the core body 11.

A distributor plate 23 (head spreader) or a distributor layer can also be arranged between at least one heat-conducting element 26 and the associated core body 11. Such a distributor plate 23a can also be arranged between the heat conducting element 26 and the base plate 8. The distributor plate 23, 23a can be connected to the core body 11 via an adhesive layer 24 with a thermal conductivity of λ>0.8 W/(m-K) and/or a shear modulus of G<10 MPa. As the adhesive layer 24, for example an adhesive layer, is extremely thin, a low thermal conductivity λ of λ>0.8 W/(m-K) is also sufficient here. Furthermore, in order to be able to compensate for different thermal expansion coefficients between the core bodies 11 and the distributor plate 23, it is advantageous to provide the adhesive layer or generally the adhesive layer 24 with a shear modulus of G≥10 MPa. The adhesive layer 24 can of course also be provided directly between the heat conducting element 26 and the core body 11 if, for example, no distributor plate 23 is provided. A thickness of the distributor plate 23, 23a or a distributor layer is in the range of 0.2 to 2.0 mm. The distributor plate 23, 23a can thereby cause an increase in the heat-transferring contact surface between the core body 11 and the heat-conducting element 26 or between the base plate 8 and the heat-conducting element 26.

Several advantages can be achieved with the floor assembly 1 according to the invention:
robust, tolerance-compensating connection of conductive heat-conducting elements 26 between core bodies 11 and cooling plate 29,
the heat conducting element 26 is connected in the central area 18 with a low flux density,
simple, cost-effective and space-saving thermal connection (few components, simple design),
combination of aluminum shielding and cooling plate 29 possible.

1. A floor assembly for an inductive charging device for inductive charging of a motor vehicle parked on an underground, comprising:
a base plate extending transversely to a spacing direction in the shape of a plate;
at least one flat coil including a conductor, the at least one flat coil disposed spaced apart from the base plate in the spacing direction;
a core arrangement for guiding a magnetic flux, the core arrangement disposed spaced apart from the base plate and the at least one flat coil in the spacing direction and arranged between the base plate and the conductor;
the core arrangement including at least one core body extending transversely to the spacing direction in the form of a plate, the at least one core body having a central area and at least one edge area;
the at least one core body is held via the at least one edge area;
a lower cavity formed between the at least one core body and the base plate; and
at least one elastic heat-conducting element connecting an associated core body of the at least one core body to the base plate in a heat-transferring manner, the at least one heat-conducting element extending from the central area of the associated core body through the lower cavity to the base plate.

2. The floor assembly according to claim 1, wherein at least one of:
the at least one heat-conducting element includes a material with a thermal conductivity greater than 10 W/(mK); and
the at least one heat-conducting element has a thermal resistance Rₜₕ between a connection surface to the associated core body and a connection surface to the base plate of Rₜₕ less than 0.5 K/W.

3. The floor assembly according to claim 1, wherein the at least one heat-conducting element is at least partially composed of metal.

4. The floor assembly according to claim 1, wherein at least one of:
the base plate includes at least one cooling channel through which a coolant is flowable; and
the base plate is at least partially composed of metal.

5. The floor assembly according to claim 1, wherein the at least one heat-conducting element is structured as at least one of a sheet metal strip and a sleeve with a thickness of 0.5 mm to 2.0 mm.

6. The floor assembly according to claim 1, further comprising at least one support disposed between the at least one core body and the base plate, wherein the at least one support extends through the lower cavity in the spacing direction and supports the at least one core body at the at least one edge area.

7. The floor assembly according to claim 6, wherein the at least one support is composed of plastic.

8. The floor assembly according to claim 6, further comprising a buffer element is arranged between the base plate and the at least one support.

9. The floor assembly according to claim 1, wherein the at least one heat-conducting element is connected to at least one of the associated core body and the base plate via a heat-conducting layer.

10. The floor assembly according to claim 1, wherein a spring stiffness of the at least one heat-conducting element is 13 N/mm to 130 N/mm.

11. The floor assembly according to claim 1, further comprising at least one of a distributor plate and a distributor layer arranged between the at least one heat-conducting element and at least one of the associated core body and the base plate.

12. The floor assembly according to claim 11, wherein the at least one of the distributor plate and the distributor layer is connected to the associated core body via an adhesive layer with at least one of (i) a thermal conductivity greater than 0.8 W/(mK) and (ii) a shear modulus less than 10 MPa.

13. The floor assembly according to claim 1, wherein the at least one heat-conducting element includes a stranded wire formed from a plurality of individual wires.

14. The floor assembly according to claim 13, wherein the plurality of individual wires of the stranded wire are 20 mm to 100 mm longer than a distance between the base plate and the at least one core body in the spacing direction.

15. The floor assembly according to claim 1, wherein the at least one heat-conducting element is preloaded against the base plate and the associated core body when in an installed state.

16. The floor assembly according to claim 14, wherein the at least one heat-conducting element has an extension in the spacing direction which is 0.5 mm to 5.0 mm greater than a largest distance occurring between the associated core body and the base plate.

17. The floor assembly according to claim 1, wherein:
the at least one heat-conducting element includes a material with a thermal conductivity greater than 50 W/(mK); and
the at least one heat-conducting element has a thermal resistance Rₜₕ between a connection surface to the associated core body and a connection surface to the base plate of Rₜₕ less than 0.1 K/W.

18. The floor assembly according to claim 9, wherein the heat-conducting layer is at least one of a thermal oil, an adhesive, a thermal grease, a heat-conducting paste, and a solder.

19. The floor assembly according to claim 11, wherein the at least one heat-conducting element is connected to the at least one of the distributor plate and the distributor layer via a heat-conducting layer.

20. The floor assembly according to claim 19, wherein the heat-conducting layer is at least one of a thermal oil, an adhesive, a thermal grease, a heat-conducting paste, and a solder.
